(19) United States
(12) Patent Application Publication
(10) Pub. No.: US 2007/0075011 A1
(43) Pub. Date: Apr. 5, 2007

(54) Installation and method for purifying a cryogenic liquid

(76) Inventor: Jean-Pierre Germain, Montigny Le Bretonneux (FR)

Correspondence Address: AIR LIQUIDE, 2700 POST OAK BOULEVARD, SUITE 1800, HOUSTON, TX, 77056, US

(21) Appl. No.: 10/576,398

(22) PCT Filed: Oct. 18, 2004
(86) PCT No.: PCT/FR04/50504

§ 371 Date: Nov. 30, 2006

(30) Foreign Application Priority Data
Oct. 20, 2003 (FR) 0350712

(51) Int. Cl. B01D 24/00

(52) U.S. Cl. 210/459; 138/140; 277/602; 285/125.1

(57) ABSTRACT

Said installation comprises a liquid circulation pipe (13), having an upstream portion (21), a downstream portion (23) and a filtering member (37), inserted between the upstream portion (21) and the downstream portion (23), at least one channel (51) being provided in said filtering member. The channel (51) is at least partially defined by a porous wall (57). Said pipe (13) comprises a double vacuum thermal insulation envelope (14), containing an insulating material, in a part of which the filtering member (37) is secured. One of said portions (21) opens out facing an end of said channel (51). The other of said portions (23) opens out facing at least one area (59) of the porous wall (57). Said invention applies to the production of high flow rate sterile cryogenic fluids.

The present invention relates to an installation for purifying a cryogenic liquid, of the type comprising:
a liquid flow pipe having an upstream portion and a downstream portion;
a filtration member interposed between the upstream portion and the downstream portion and in which there is formed at least one duct extending along a flow axis between an open end and a closed-off end, said duct being at least partially defined by a porous wall (having a pore size which is preferably less than or equal to 0.2 μm).

This method applies particularly to the high-output production (above 1 t/h) of liquid nitrogen or else sterile carbon dioxide, specifically for use in the agri-food and electronics industries and in the medical sector.

A known way of sterilizing a cryogenic liquid is to pass it through a porous filter having a pore size substantially equal to 0.2 μm so as to retain bacteria, particles or other potentially dangerous substances or organisms within the filter. The filter must be kept at a temperature close to the temperature of the liquid so as to prevent the formation of bubbles or microbubbles which have a diameter greater than or equal to 0.2 μm and are liable to clog the filter.

In an installation of the aforementioned type (U.S. Pat. No. 4,759,848), the filter is thus submerged in a tank of subcooled cryogenic liquid.

Such installations do not provide complete satisfaction. This is because the upstream and downstream portions of the pipe must be inserted in the tank in a sealed manner and the tank has to be regularly supplied with subcooled cryogenic liquid.

It is therefore difficult for such an installation to be able to be used for the production of a sterile cryogenic liquid on an industrial scale with an output above 1 t/h.

The main aim of the invention is to overcome this disadvantage, that is to say to create an installation for purifying a cryogenic liquid which is both simple and can easily be used on an industrial scale.

To this end, the subject of the invention is an installation of the aforementioned type as defined in claim 1 below.

The installation according to the invention may have one or more of the following features, taken in isolation or in all technically possible combinations:
said first sealing means are maintained in compression by the filtration member and said first portion at the temperature of the cryogenic liquid which is intended to be purified;
the part of the first portion adjacent to said open end extends along the flow axis (Y-Y′);
said first portion consists of said upstream portion, the angle formed by the general axis (X-X′) of this upstream portion and the flow axis (Y-Y′) being between about 10° and about 30°;
said angle is substantially equal to 15°;
the flow axis (Y-Y′) is substantially vertical and said downstream portion emerges opposite a region of the porous wall in the vicinity of the closed-off end of said filtration member, which is the upper end of this member;
a prefiltration member having a pore size greater than or equal to 100 μm is arranged in the upstream portion of the pipe;
said porous wall has a pore size which is less than or equal to 0.20 μm.

Another subject of the invention is a method for purifying a cryogenic liquid, characterized in that it is implemented in an installation as described above.

Embodiments of the invention will now be described with reference to the appended drawings, in which:

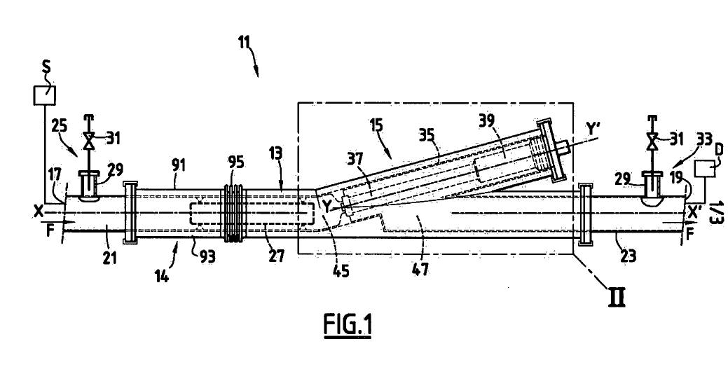

FIG. 1 is a view of a first installation according to the invention;

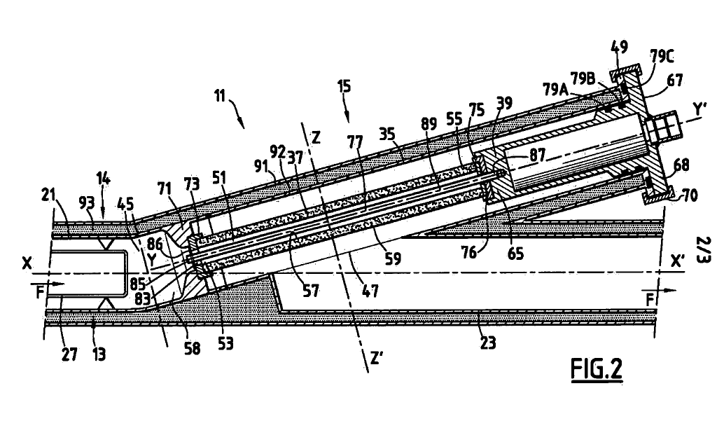

FIG. 2 is a view in section, taken on a vertical mid-plane, of a detail of FIG. 1; and

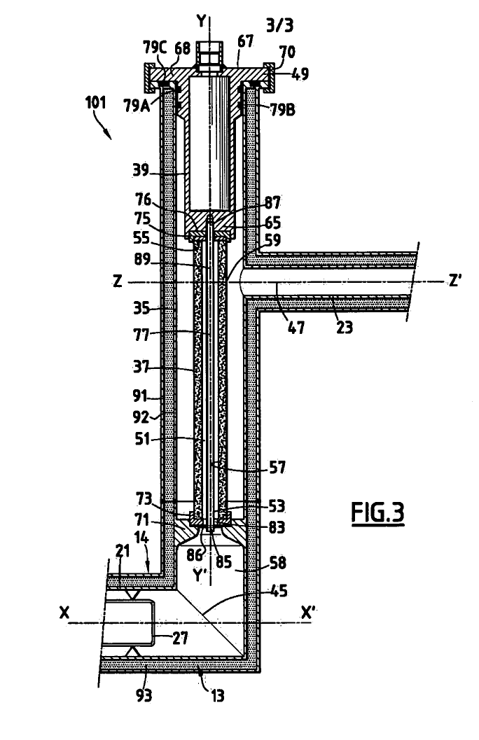

FIG. 3 is a view in section, taken on a vertical mid-plane, of a detail of a second installation according to the invention.

The installation represented in FIGS. 1 and 2 is intended for the production of a sterile cryogenic liquid with an output above 1 t/h. The cryogenic liquid, which may be nitrogen, argon or carbon dioxide, for example, is intended, following purification, to be used particularly in the agri-food, electronics and health sectors.

As illustrated in FIG. 1, the installation 11 has a pipe 13 provided with a double-walled thermal insulation jacket 14, and a filtration unit 15.

In the following text the terms “upstream” and “downstream” are to be understood in relation to the direction of flow of the cryogenic liquid in the installation 11 (from left to right in FIG. 1, as indicated by the arrows F).

The pipe 13 extends along a longitudinal axis X-X′ between an upstream inlet 17, intended to be connected to a source S of contaminated cryogenic liquid, and a downstream outlet 19 intended to be connected to a device D for the use of the purified cryogenic liquid. Said pipe comprises an upstream portion 21 and a downstream portion 23.

The upstream portion 21 of the pipe 13 extends between the upstream inlet 17 and the filtration element 15. It comprises an upstream branch connection 25 and a prefiltration member 27.

The upstream branch connection 25 comprises a transverse stub 29 fitted with a valve 31. The branch connection 25 is intended to be connected to a steam source or to a dry gas source.

The prefiltration member 27 is arranged inside the upstream portion 21. It comprises a porous body whose pore size is, for example, greater than 100 μm, said body retaining the large-size impurities which may be present in the source of cryogenic liquid to be purified. This member 27 prevents these impurities from impairing and obstructing the subsequent filtration element 15.

The downstream portion 23 extends between the filtration element 15 and the outlet 19. It comprises a downstream branch connection 33 with a structure analogous to the upstream branch connection 25 and is intended to be connected to a vent.

As illustrated in FIG. 2, the filtration element 15 comprises a lateral branch 35 of the pipe 13, in which branch is arranged a filtration member 37, a thermal insulation member 39 and sealing means for these members.

The branch 35 extends between, on the one hand, an outlet end 45 of the upstream portion 21 and, on the other hand, an inlet end 47 of the downstream portion 23 and a rim 49 provided at the free end of the branch 35.

The branch 35 extends parallel to an ascending flow axis Y-Y′, which is inclined with respect to the longitudinal axis X-X′. The angle formed by the flow axis Y-Y′ and the longitudinal axis X-X′ is greater than 10°. In the example represented in FIG. 2, this angle is substantially equal to 15°.

The filtration member 37 comprises a membranous body made of microporous ceramic.

This body has an elongate shape which extends along the flow axis Y-Y′ . It comprises a set of ducts 51 which are parallel to the flow axis Y-Y′. Only one duct 51 is represented in FIG. 2.

These ducts 51 emerge at the upstream end 53 of the filtration member 37 and are closed off at the downstream end 55 of this member 37.

The ducts 51 are defined by lateral filtration walls 57 whose pore size is less than 0.22 μm. In the example represented in FIG. 2, the pore size of the walls 57 is substantially equal to 0.2 μm.

The upstream end 53 of the filtration member 37 is arranged opposite the outlet end 45 of the upstream portion 21, which extends in the part 58 in the vicinity of this end along the flow axis Y-Y′.

Moreover, a region 59 of the porous wall 57 is arranged opposite the inlet end 47 of the downstream portion 23. The downstream portion 23 is elbowed at this end 47, and the angle formed by the flow axis Y-Y′ and the axis Z-Z′ of the downstream portion, in the vicinity of its inlet end 47, is substantially equal to 90°.

Thus, the fluid to be filtered enters the filtration member 37 via the ducts 51 and leaves this member 37 through the lateral filtration wall 57 so as to be picked up in the downstream portion 23.

The angle formed between the longitudinal axis X-X′ and the flow axis Y-Y′ is preferably between 10° and 30° so as to limit the pressure drop across the filtration member 37, at the same time allowing easy access to the member 37 from the outside of the pipe for the purpose of maintenance operations.

The insulation member 39 comprises a hollow tubular body whose diameter is less than the internal diameter of the branch 35. This body extends along the flow axis Y-Y′ between a lower end 65 opposite the filtration member 37 and an upper end 67 provided with a flange 68 in sealed bearing contact with the rim 49 of the branch 35, the assembly being securely fastened by means of a collar 70.

The length of the insulation member 39 is selected such that the temperature at its upper end 67, when its lower end 65 is immersed in cryogenic liquid, is substantially equal to the temperature prevailing outside the installation 11.

The sealing means comprise a filter support 71, an upstream cup 73, a downstream cup 75, a central screw-bolt 77 and three annular seals 79A, 79B and 79C.

The filter support 71 has an internal annular flange arranged in the pipe 13 between the upstream portion 21 and the branch 35.

The upstream cup 73 rests on the filter support 71 and accommodates the upstream end 53 of the filtration member 37. The bottom of this upstream cup 73 comprises a plurality of slots 83 opposite the ducts 51. Only one slot is represented in FIG. 2.

The downstream cup 75 accommodates the downstream end 55 of the filtration member 37 and is accommodated in a recess 76 in the lower end 65 of the insulation member 39.

The central screw-bolt 77 comprises a head 85 provided with a transverse pin 86 bearing on the upstream cup 73, and a threaded portion 87 screwed into a tapped hole in the insulation member 39. Said screw-bolt additionally comprises a central portion 89 which connects the head 85 to the threaded portion 87. This central portion 89 is arranged in a duct 51 of the filtration member 37.

The upstream 73 and downstream 75 cups are maintained in compression between the filter support 71 and the insulation member 39.

To this end, the filtration member 37 and the insulation member 39 are preferably mounted in the branch 35 in the following manner.

In a first step, the screw-bolt 77 is screwed into the insulation member 39. The downstream cup 76, the filtration member 37 and the upstream cup 73 are then successively slipped onto the screw-bolt 77. Next, the pin 86 is fitted into the head 85 so as to fasten the cups 73 and 76 together with the filtration member 37 with respect to the insulation member 39.

In a second step, the assembly thus formed is mounted in the branch 35, bearing on the filter support 71, under an axial stress corresponding to a minimum compression of 3 millimeters and is crimped with the aid of the collar 70.

The stress applied to these cups 73 and 75 at ambient temperature is calculated such that the release of this stress compensates for the contraction of the cups 73 and 75, of the filtration member 37 and of the insulation member 39 at the temperature of the cryogenic liquid which is intended to be purified.

Thus, when the temperature of these members 37 and 39 decreases and they contract on contact with the cryogenic fluid in the branch 35 of the pipe 13, sealing between, on the one hand, the filter support 71 and the filtration member 37 and, on the other hand, the filtration member 37 and the insulation member 39 is ensured in spite of the stresses being released within the upstream and downstream cups 73 and 75, since the latter are maintained in slight compression.

Moreover, the annular seals 79A and 79B are arranged in corresponding grooves provided in the vicinity of the upper end 67 of the insulation member 39 so as to provide sealing between the interior and exterior of the pipe 13. The seal 79C is compressed by the flange 68 in a circular groove in the rim 49.

The double-walled insulation jacket 14 covers the whole of the pipe 13 and the whole of the branch 35. It comprises an outer shell 91 and an inner shell 92.

The outer shell 91 additionally comprises an annular compensating bellows 95 which may contract or expand longitudinally along the axis X-X′ as a function of variations in the length of the pipe 13 under the effect of temperature variations.

The annular space between the shells 91 and 92 thus defines a vacuum-sealed chamber 93.

A laminar insulation material is arranged in the chamber 93 and is held therein under vacuum. An example of insulation material comprises an alternating arrangement of glass fabric or Mylar fabric layers and aluminum foils.

The pressure in the chamber 93 is preferably between 5×10⁻⁴ and 10⁻⁶ mbar, preferably below 10⁻⁵ mbar.

An example will now be given of the operation of the installation 11 according to the invention for the production of sterile liquid nitrogen.

In a first step, the upstream branch connection 25 is connected to a steam source and the downstream branch connection 33 is connected to a vent. Steam is then made to circulate for a predetermined time between the upstream and downstream branch connections 25 and 33, successively through the upstream portion 21, the prefiltration member 27, the filtration member 37 and the downstream portion 23, in order to sterilize the installation 11 (this being done for example to implement the pharmacopeia recommendation of 121° C. for 90 minutes).

In a second step, the upstream branch connection 25 is connected to a pressurized dry gas source. Pressurized dry gas is then made to circulate in order to effect complete drying of the installation 11 (for example 105° C. for 90 minutes).

In a third step, the inlet 17 of the pipe 13 is connected to the contaminated pressurized liquid nitrogen source. The flow rate of nitrogen introduced into the pipe 13 is gradually increased so as to fill the prefiltration member 27 and then the filtration member 37, which reach a temperature close to the temperature of the cryogenic liquid. During this drop in temperature, the elements of the installation in contact with the cryogenic liquid contract. The contraction of the pipe 13 is compensated for by the bellows 95.

The cryogenic liquid passes through the prefiltration member 27 in order to filter the large-size impurities and then reaches the filtration member 37.

The contraction of the filtration member 37 in contact with the cryogenic liquid is compensated for by the stresses being released within the upstream and downstream cups 73, 75, which are maintained in slight compression, with the result that sealing is maintained at the upstream and downstream ends 53 and 55 of the filtration member 37. It should also be pointed out that, at the temperature of the cryogenic fluid, this mechanical compression is accompanied by the differential compression between the stainless steel and the ceramic.

The cryogenic liquid then enters the ducts 51 of the filtration member 37 and passes through the porous wall 57 in a transverse direction to the flow axis Y-Y′. During this passage, all of the impurities and/or microorganisms with a size which is greater than or equal to 0.22 μm are retained in the ducts 51.

The purified liquid nitrogen is then picked up in the downstream portion 23 right up to the outlet 19 of this portion 23, where it is delivered to the user. This nitrogen is sterile.

By way of example, in order to obtain a sterile nitrogen output of around 2 to 3 metric tons per hour, the upstream portion 21 and the downstream portion 23 of the pipe 13 have an inside diameter of 33.7 mm (DN25) for a nominal pressure of 7 bar absolute. The filtration member 37 has a length of between 600 and 1000 mm and a filtration area of between 0.15 and 0.25 m².

In the case of liquid carbon dioxide, the inside diameter of the pipe 13 is 21.3 mm (DN15) for a nominal pressure of 40 bar absolute.

A second installation 101 according to the invention is represented in FIG. 3. By contrast with the first installation 11, the angle formed by the flow axis Y-Y′ and the pipe axis X-X′ is equal to 90°, with the result that the axis Y-Y′ is vertical. This angle makes it possible to limit or even exclude water condensation on the insulation member 39.

Moreover, the downstream portion 23 emerges opposite a region 59 of the filtration wall which is in the vicinity of the upper end 55 of the filtration member 37. This arrangement makes it possible to substantially fill the entirety of the filtration member 37 and the annular space surrounding it with cryogenic liquid before this liquid is delivered to the outlet 19 of the downstream portion 23.

By virtue of the invention which has just been described it is possible to make available a particularly simple and inexpensive installation for the production of a sterile cryogenic liquid.

This installation makes it possible to achieve a production output above 1 t/h.

Moreover, the sterilization and maintenance operations for such an installation are particularly simplified by the structure of the filtration element.

However, it should be stressed above all that the major advantage of such an installation is that it may be easily installed “in line” in an existing cryogenic liquid supply pipe without requiring any kind of immersion in a bath of cryogenic liquid.

1-9. (canceled)

10. An installation (11) for purifying a cryogenic liquid, of the type comprising:
a) a liquid flow pipe (13) having an upstream portion (21) and a downstream portion (23); and
b) a filtration member (37) interposed between the upstream portion (21) and the downstream portion (23) and in which there is formed at least one duct (51) extending along a flow axis (Y-Y′) between an open end (53) and a closed-off end (55), said duct being at least partially defined by a porous wall (57),
characterized by the implementation of the following measures:
i) the pipe (13) has a double-walled vacuum thermal insulation jacket (14) containing an insulation material in its inter-wall area, which jacket defines a flow space in a part of which the filtration member (37) is secured, a first of said portions (21) emerging into the open end (53) of said duct (51) via interposed first sealing means (73), the other of said portions (23) emerging opposite at least one region (59) of the porous wall (57);
ii) the pipe (13) comprises a branch (35) extending parallel to said flow axis (Y-Y′) between said first portion (21) and a free end (49), said branch (35) containing at least part of the filtration member (37) and a thermal insulation member (39) which is mounted so as to bear, on the one hand, on the closed-off end (55) of the filtration member (37) and, on the other hand, on the free end (49) of said branch (35); and
iii) downstream sealing means (75) are arranged between the filtration member (37) and the insulation member (39), these downstream sealing means (75) being maintained in compression by the filtration member (37) and the insulation member (39) at the temperature of the cryogenic liquid which is intended to be purified.

11. The installation of claim 10, characterized in that said first sealing means (73) are maintained in compression by the filtration member (37) and said first portion (21) at the temperature of the cryogenic liquid which is intended to be purified.

12. The installation of claim 10, characterized in that the part (58) of the first portion (21) adjacent to said open end (53) extends along the flow axis (Y-Y′).

13. The installation of claim 10, characterized in that said first portion consists of said upstream portion (21), the angle formed by the general axis (X-X′) of this upstream portion (21) and the flow axis (Y-Y′) being between about 10° and about 30°.

14. The installation of claim 13, characterized in that said angle is substantially equal to 15°.

15. The installation (101) of claim 10, characterized in that the flow axis (Y-Y′) is substantially vertical and in that said downstream portion (23) emerges opposite a region (59) of the porous wall (57) in the vicinity of the closed-off end (55) of said filtration member (37), which is the upper end of this member (37).

16. The installation of claim 10, characterized in that a prefiltration member (27) having a pore size greater than or equal to 100 μm is arranged in the upstream portion (21) of the pipe (13).

17. The installation of claim 10, characterized in that said porous wall has a pore size which is less than or equal to 0.20 μm.

18. A method for purifying a cryogenic liquid, characterized in that it is implemented in an installation (11, 101) as claimed in claim 10.
